(19) United States
(12) Patent Application Publication
(10) Pub. No.: US 2014/0226363 A1
(43) Pub. Date: Aug. 14, 2014

(54) BACKLIGHT ASSEMBLY AND DISPLAY DEVICE INCLUDING THE SAME

(71) Applicant: Samsung Display Co., Ltd., Yongin-City (KR)

(72) Inventors: Myung-Seok KWON, Seongnam-si (KR); So Jeong LA, Suwon-si (KR); Do Hun KIM, Masan-si (KR); Young Chun KIM, Seoul (KR); Young-Min PARK, Hwaseong-si (KR); Jung Hoon SHIN, Seongnam-si (KR)

(21) Appl. No.: 13/933,253

(22) Filed: Jul. 2, 2013

(30) Foreign Application Priority Data
Feb. 14, 2013 (KR) 10-2013-0015970

(51) Int. Cl. F21V 8/00

(52) U.S. Cl. CPC G02B 6/0011
USPC 362/613; 362/611

(57) ABSTRACT

A backlight assembly includes a first light guide member; a second light guide member overlapping the first light guide member; a groove defined in the second light guide member; and a light source unit in the groove. The light source unit generates and supplies light to the first light guide member and the second light guide member.

This application claims priority to Korean Patent Application No. 10-2013-0015970 filed on Feb. 14, 2013, and all the benefits accruing therefrom under 35 U.S.C. §119, the entire contents of which are incorporated herein by reference.

### BACKGROUND

(a) Field

The invention relates to a backlight assembly and a display device including the same. More particularly, the invention relates to a backlight assembly, and a display device including the same, that can uniformly transmit light emitted from a light source to an entire display panel.

(b) Description of the Related Art

A display device is employed for a computer monitor, a television, a mobile phone, and the like which are widely used. The display device includes a cathode ray tube display device, a liquid crystal display device, a plasma display device, and the like.

The liquid crystal display device, which is one of the more common types of flat panel displays, includes a display panel having two display panel substrates with field generating electrodes such as a pixel electrode and a common electrode, and a liquid crystal layer interposed therebetween. The liquid crystal display device generates an electric field in the liquid crystal layer by applying voltages to the field generating electrodes, determines the alignment of liquid crystal molecules of the liquid crystal layer by the generated electric field, and controls polarization of incident light, thereby displaying an image.

Since the liquid crystal display device is not a self-luminous device, a light source is needed. The light source may be a separately mounted artificial light source or natural light. Examples of the artificial light source used in the liquid crystal display device are a light emitting diode (“LED”), a cold cathode fluorescent lamp (“CCFL”), and an external electrode fluorescent lamp (“EEFL”).

In order for light emitted from the artificial light source to reach an entire display panel with uniform luminance, a light guide member such as a light guide plate (“LGP”) is required.

### SUMMARY

One or more exemplary embodiment of the invention provides a backlight assembly and a display device including the same that uniformly provide light emitted from a light source to a display panel.

Also, one or more exemplary embodiment of the invention provides a backlight assembly and a display device including the same that minimize a bezel region.

An exemplary embodiment of a backlight assembly includes: a first light guide member; a second light guide member overlapping the first light guide member; a groove defined in the second light guide member; and a light source unit in the groove, and generating and supplying light to the first light guide member and the second light guide member.

The second light guide member may overlap an inclined edge of the first light guide member in a plan view. The first light guide member may include a first portion having a first thickness and overlapping the second light guide member, and a remaining second portion having a second larger than the first thickness.

An upper surface of the second portion of the first light guide member and an upper surface of the second light guide member may be coplanar.

The light source unit may include a first light source which generates and supplies the light to the first light guide member, a second light source which generates and supplies the light to the second light guide member, and a printed circuit board (“PCB”) upon which the first light source and the second light source are disposed.

The first light source may face the inclined edge of the first light guide member overlapped by the second light guide member, and the second light source may be inside the groove.

The first light source and the second light source may respectively include a number of light emitting diode (“LED”) chips. A ratio of the number of LED chips of the second light source to the number of LED chips of the first light source may be substantially equal to a ratio of a planar area of the second light guide member to a planar area of the first light guide member.

The first light guide member may include a first portion having a first thickness and overlapping the second light guide member, and a remaining second portion having a second thickness larger than the first portion. At a boundary between the first and second portions of the first light guide member, a side surface of the first light guide member may face a side surface of the second light guide member. The backlight assembly may further include a reflection sheet between the facing side surfaces.

A protruded portion of the second light guide member may overlap an upper surface of the light source unit.

In a cross-sectional view, the light source unit may include a front surface facing a light incident side surface of the first light guide member, a rear surface opposing the front surface, and a first inclined surface connecting the upper and rear surfaces. The protruded portion of the second light guide member may include a second inclined surface at the groove. The second inclined surface the second light guide member may face the first inclined surface of the light source unit.

The first light guide member may include a first portion having a first thickness and overlapping the second light guide member, and a remaining second portion having a second thickness larger than the first portion. At a boundary between the first and second portions of the first light guide member, a side surface of the first light guide member may face a side surface of the second light guide member. In a cross-sectional view, the side surface of the second light guide member may be inclined.

An exemplary embodiment of a display device includes a display panel, and a backlight assembly which generates and supplies light to the display panel. The backlight assembly includes: a first light guide member; a second light guide member overlapping the first light guide member; a groove defined in the second light guide member; and a light source unit in the groove, where the light source unit generates and supplies the light to the first light guide member and the second light guide member.

The second light guide member may overlap an inclined edge of the first light guide member in a plan view. The first light guide member may include a first portion having a first thickness and overlapping the second light guide member, and a remaining second portion having a second larger than the first thickness.

An upper surface of the second portion of the first light guide member and an upper surface of the second light guide member may be coplanar.

The light source unit may include: a first light source which generates and supplies the light to the first light guide member; a second light source which generates and supplies the light to the second light guide member; and a PCB upon which the first light source and the second light source are disposed.

The first light source may face the inclined edge of the first light guide member overlapped by the second light guide member, and the second light source may be inside the groove.

The first light source and the second light source may respectively include a number of LED chips. A ratio of the number of LED chips of the second light source to the number of LED chips of the first light source may be substantially equal to a ratio of a planar area of the second light guide member to a planar area of the first light guide member.

The first light guide member may include a first portion having a first thickness and overlapping the second light guide member, and a remaining second portion having a second thickness larger than the first portion. At a boundary between the first and second portions of the first light guide member, a side surface of the first light guide member may face a side surface of the second light guide member. The backlight assembly may further include a reflection sheet between the facing side surfaces.

A protruded portion of the second light guide member may overlap an upper surface of the light source unit.

In a cross-sectional view, the light source unit may include a front surface facing a light incident side surface of the first light guide member, a rear surface opposing the front surface, and a first inclined surface connecting the upper and rear surfaces. The protruded portion of the second light guide member may include a second inclined surface at the groove. The second inclined surface may face the first inclined surface.

The first light guide member may include a first portion having a first thickness and overlapping the second light guide member, and a remaining second portion having a second thickness larger than the first portion. At a boundary between the first and second portions of the first light guide member, a side surface of the first light guide member may face a side surface of the second light guide member. The side surface of the second light guide member may be inclined.

One or more exemplary embodiment of the backlight assembly and the display device including the same according to the invention has the following effects.

The backlight assembly includes two light guide members, and the light source units respectively supply the light to the two light guide members such that the uniformity of light supplied to the display panel may be improved.

Also, the light source unit is in the groove of a light guide member such that a bezel region of the display device may be reduced.

### BRIEF DESCRIPTION OF THE DRAWINGS

The above and other features of this disclosure will become more apparent by describing in further detail exemplary embodiments thereof with reference to the accompanying drawings, in which:

FIG. 1 is an exploded perspective view of an exemplary embodiment of a display device according to the invention.

FIG. 2 is a perspective view of a portion of an exemplary embodiment of a backlight assembly according to the invention.

FIG. 3 is a cross-sectional view of the backlight assembly in FIG. 2 taken along line III-III, according to the invention.

FIG. 4 is a perspective view of a portion of an exemplary embodiment of a first light guide member of a backlight assembly according to the invention.

FIG. 5 is a perspective view of an exemplary embodiment of a second light guide member of a backlight assembly according to the invention.

FIG. 6 is a perspective view of an exemplary embodiment of a light source unit of a backlight assembly according to the invention.

FIG. 7 is a cross-sectional view of another exemplary embodiment of a backlight assembly according to the invention.

FIG. 8 is a perspective view of a portion of still another exemplary embodiment of a backlight assembly according to the invention.

FIG. 9 is a cross-sectional view of the backlight assembly in FIG. 8 taken along line IX-IX, according to the invention.

FIG. 10 is a perspective view of a portion of another exemplary embodiment of a first light guide member of a backlight assembly according to the invention.

FIG. 11 is a perspective view of another exemplary embodiment of a second light guide member of a backlight assembly according to the invention.

FIG. 12 is a perspective view of another exemplary embodiment of a light source unit of a backlight assembly according to the invention.

FIG. 13 is a perspective view of a portion of yet another exemplary embodiment of a backlight assembly according to the invention.

FIG. 14 is a cross-sectional view of the backlight assembly in FIG. 13 taken along line XIV-XIV, according to the invention.

FIG. 15 is a perspective view of still another exemplary embodiment of a second light guide member of a backlight assembly according to the invention.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

In the drawings, the thickness of layers, films, panels, regions, etc., are exaggerated for clarity. Like reference numerals designate like elements throughout the specification. As used herein, the term “and/or” includes any and all combinations of one or more of the associated listed items.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “under” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be described in detail with reference to the accompanying drawings.

A display device such as a liquid crystal display device includes a backlight assembly which generates and provides light to a display panel upon which an image is displayed. The backlight assembly may include a light source disposed to face one side of a light guide member. An incident portion of the light guide member which receives the light may be particularly clear or bright compared with other portions. Accordingly, it is difficult for the entire display panel to have uniform luminance. Also, since the light source is disposed on outside a planar boundary of the light guide member, a reduction of a bezel region of the liquid crystal display device due to a thickness of the light source, and a distance between the light source and the light guide member, is limited.

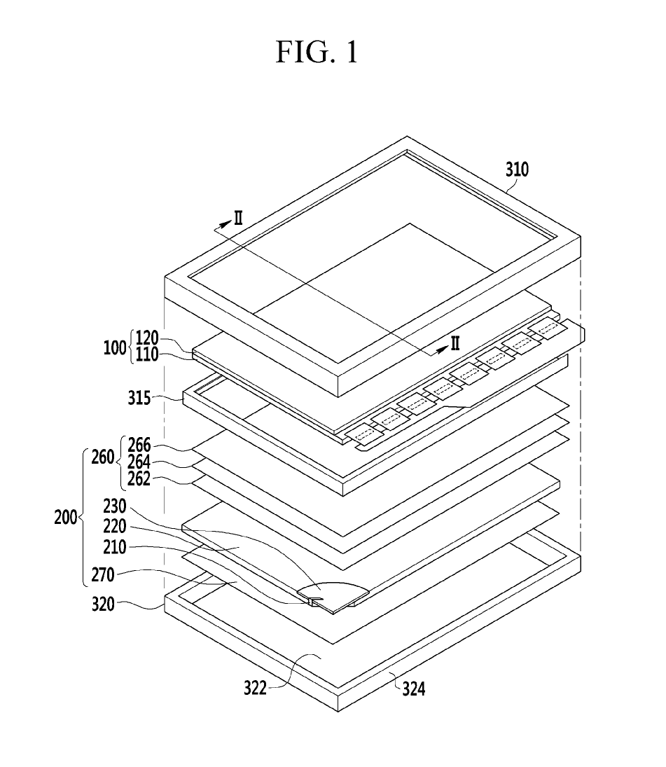

Firstly, an exemplary embodiment of a backlight assembly and a display device including the same according to the invention will be described with reference to FIG. 1.

FIG. 1 is an exploded perspective view of an exemplary embodiment of a display device according to the invention.

As shown in FIG. 1, a display device includes a backlight assembly 200 generating and supplying light, and a display panel 100 receiving the light from the backlight assembly 200 to display an image. Further, in order to fix the backlight assembly 200 and the display panel 100, an upper cover 310, a mold frame 315, and a lower cover 320 are coupled to each other.

The backlight assembly 200 includes a light source unit 210 generating and supplying light, a first light guide member 220 and a second light guide member 230 receiving the light from the light source unit 210 and uniformly supplying the light to the display panel 100, an optical sheet 260 disposed under the display panel 100, and a reflector 270 reflecting the light emitted from the light source unit 210.

In the illustrated exemplary embodiment, the light source unit 210 is disposed at one side corner of the first light guide member 220 and in the second light guide member 230. The first and second light guide members 220 and 230 may collectively form a light guide member unit.

The first light guide member 220 is a similar shape and size to the display panel 100.

The second light guide member 230 is disposed on the first light guide member 220 to overlap one edge of the first light guide member 220. In the illustrated exemplary embodiment, the second light guide member 230 is positioned at one corner of the first light guide member 220 and has a smaller planar area than the first light guide member 220.

The optical sheet 260 increases light correction efficiency of the light that is supplied from the light source unit 210 and passed through the first light guide member 220 and the second light guide member 230, and provides a substantially uniform distribution of the light to the display panel 100. This optical sheet 260 may include a plurality of various sheets, for example, a diffuser sheet 262, a prism sheet 264 and a protecting sheet 266 that are sequentially deposited.

The diffuser sheet 262 diffuses the light emitted from the light source unit 210. The prism sheet 264 collects the light diffused from the diffuser sheet 262 in a direction perpendicular to the plane surface of the display panel 100. Most of the light passing through the prism sheet 264 is perpendicularly incident to the display panel 100. Further, the protecting sheet 266 may be disposed on the prism sheet 264, and protects the prism sheet 264 against external impact.

As described above, the optical sheet 260 including one diffuser sheet 262, one prism sheet 264 and one protecting sheet 266 is exemplified, but the invention is not limited thereto. An optical sheet 260 in which a plurality of sheets including at least any one of the diffuser sheet 262, the prism sheet 264 and the protecting sheet 266 may be used, and any one of these sheets may be omitted if necessary.

The reflector 270 may be disposed under the first light guide member 220 and the second light guide member 230. A portion of the light emitted from the light source unit 210 may escape to the bottom surface of the first light guide member 220 and/or the second light guide member 230. The reflector 270 changes a light path of the escaped light toward the display panel 100 so as to reduce or effectively prevent loss to the outside of the backlight assembly 200 of the light emitted from light source unit 210.

As the display panel 100, various display panels such as a liquid crystal display (“LCD”) panel and an electrophoretic display panel (“EDP”) may be used.

When the liquid crystal display panel is used as the display panel 100, the display panel 100 is configured such that a first substrate 110 and a second substrate 120 are laminated together while facing each other, and a liquid crystal layer (not shown) is disposed between the first substrate 110 and the second substrate 120. Although not shown, one or more gate line, one or more data line, and a thin film transistor connected to the gate and data line, are disposed on the first substrate 110. Further, the liquid crystal display panel includes a pixel electrode, which is applied with a signal from the data line when the thin film transistor is turned on by a signal applied from the gate line A common electrode may be disposed on the first substrate 110 or the second substrate 120, and an electric field is formed between the pixel electrode and the common electrode to control the alignment of liquid crystal molecules of the liquid crystal layer. Accordingly, the light incident from the backlight assembly 200 is controlled, thus displaying an image on the liquid crystal display panel.

The upper cover 310 surrounds an upper edge and side of the display panel 100 to support a front edge at a viewing side of the display panel 100.

The mold frame 315 is disposed between the upper cover 310 and the lower cover 320. The mold frame 215 includes a sidewall surrounding the display panel 100 and a surface protruding from the sidewall forming a receiving space in which the display panel 100 is received. The display panel 100 is received at an upper part based on the protruding surface of the mold frame 315, and the backlight assembly 200 is disposed therebelow.

The lower cover 320 includes a bottom surface 322, and sidewalls 324 extending and bending from the bottom surface 322 to form a receiving space in which the backlight assembly 200 is received. The display panel 100 may be shaped as a quadrangle as shown in the exemplary embodiment, and thus, the number of the sidewalls 324 of the lower cover 320 may be four. The lower cover 320 may be coupled with the upper cover 310, such that the display panel 100 and the backlight assembly 200, which are positioned therein, may be fixed in the display device.

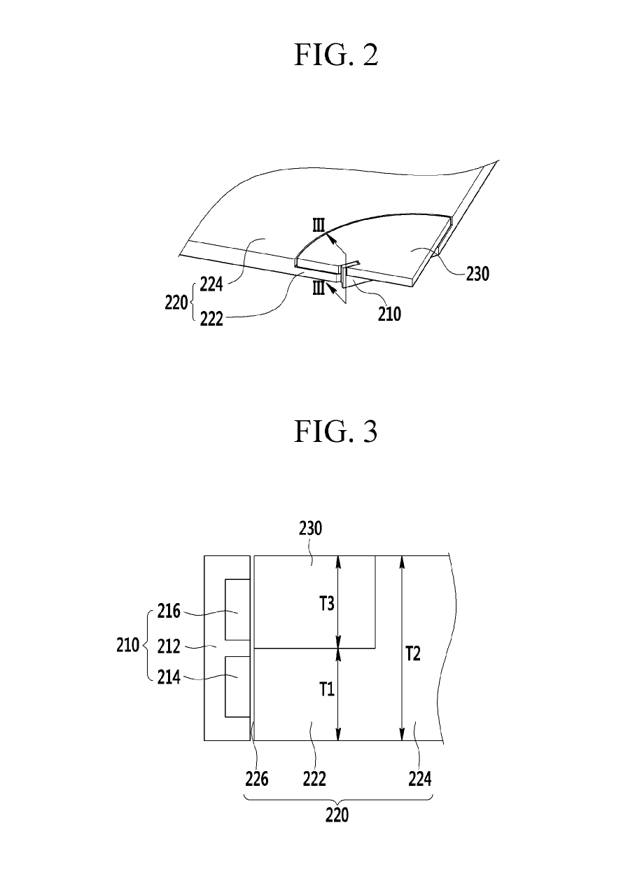

Next, exemplary embodiments of a backlight assembly according to the invention will be described with reference to FIG. 2 to FIG. 6 as well as FIG. 1.

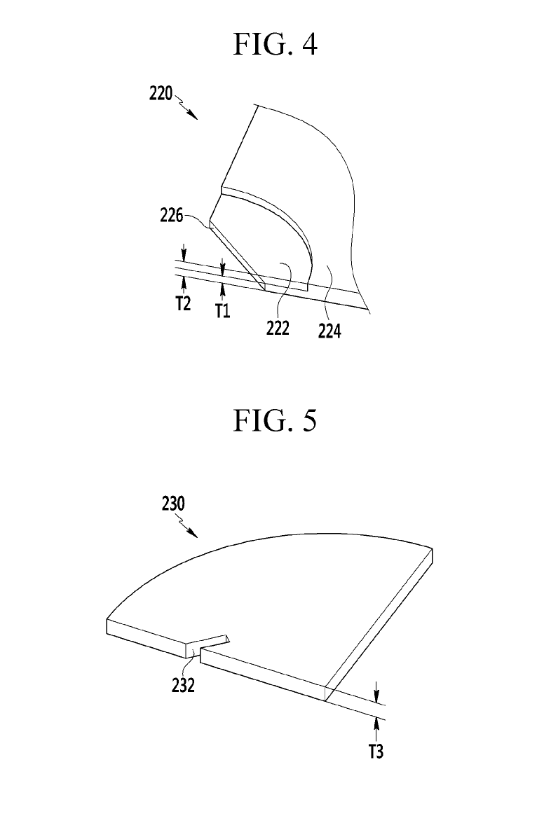

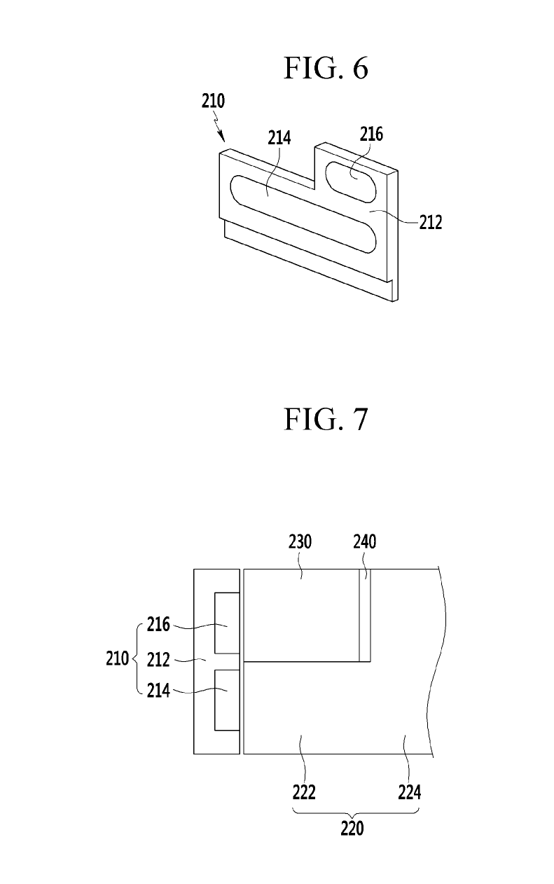

FIG. 2 is a perspective view of a portion of an exemplary embodiment of a backlight assembly according to the invention, and FIG. 3 is a cross-sectional view of the backlight assembly in FIG. 2 taken along line III-III according to the invention. FIG. 4 is a perspective view of a portion of an exemplary embodiment of a first light guide member of a backlight assembly according to the invention, FIG. 5 is a perspective view of an exemplary embodiment of a second light guide member of a backlight assembly according to the invention, and FIG. 6 is a perspective view of an exemplary embodiment of a light source unit of a backlight assembly according to the invention.

The first light guide member 220 of the backlight assembly has an upper surface in a shape of an approximate quadrangle, as shown in FIG. 1 to FIG. 3 and FIG. 4. In a plan view, a corner (otherwise referred to as an “apex”) among four apexes of the quadrangle is chamfered such as by cutting away a portion of the quadrangle. Accordingly, the upper surface of the first light guide member 220 may be substantially shaped as a pentagon in the plan view. The inclined edge at the cut apex may form an angle of about 45 degree with adjacent edges of the quadrangle. The side surface of the inclined edge of the first light guide member 220 positioned at the cut apex portion is referred to as an incision surface 226. A side surface of the second light guide member 230 may not face the incision surface 226 of the first light guide member 220 such that the incision surface 226 is exposed by the second light guide member 230.

In the exemplary embodiment, the upper surface of the first light guide member 220 is generally shaped as the approximate quadrangle and is substantially shaped as the pentagon, however, the invention is not limited thereto. The upper surface of the first light guide member 220 may be shaped as various other polygons and/or the inclined edge portion may include a curved line in the plan view.

The inclined edge where the incision surface 226 of the first light guide member 220 is positioned overlaps the second light guide member 230. The first light guide member 220 includes a first portion 222 overlapping the second light guide member 230 and a remainder of the first light guide member 220 is a second portion 224. That is, the second portion 224 of the first light guide member 220 is a portion that does not overlap the second light guide member 230. The first and second portions 222 and 224 may collectively form a single, unitary, indivisible first light guide member 220, but the invention is not limited thereto.

A cross-sectional thickness T1 of the first portion 222 of the first light guide member 220 is smaller than a cross-sectional thickness T2 of the second portion 224. The differences in thicknesses form a stepped portion of the first light guide member 220. The cross-sectional thickness T2 is taken from the upper surface of the first light guide member 220 to a lower surface of the first light guide member 220. The second light guide member 230 is positioned on the first portion 222 of the first light guide member 220, such as in the stepped portion. A cross-sectional thickness T3 of the second light guide member 230 is substantially equal to a difference between the cross-sectional thickness T2 of the second portion 224 of the first light guide member 220 and the cross-sectional thickness T1 of the first portion 222. Accordingly, the upper surface of the second portion 224 of the first light guide member 220 and the upper surface of the second light guide member 230 are coplanar with each other to form a substantially flat upper surface of the collective light guide member unit.

The second light guide member 230 may have the upper surface with a fan-shaped form as shown in FIG. 1 to FIG. 3 and FIG. 5. That is, the upper surface of the second light guide member 230 may be defined by two edges and one arc edge, such as shaped as a portion of a circle. The two edges of the second light guide member 230 may overlap the two edges of the first light guide member 220 adjacent to the incision surface 226, in the plan view. The edges of the first and second light guide members 220 and 230 may be aligned in the plan view, such that the side surfaces at the edges are coplanar. Also, the one arc edge of the second light guide member 230 may substantially overlap and/or be parallel with a boundary between the first portion 222 and the second portion 224 of the first light guide member 220. Accordingly, the boundary between the first portion 222 and the second portion 224 of the first light guide member 220 may have the arc shape.

In the illustrated exemplary embodiment described above, the upper surface of the second light guide member 230 is fan-shaped, however, the invention is not limited thereto. The upper surface of the second light guide member 230 may be polygon-shaped such as a quadrangle, a triangle, or various shapes such as an asymmetrical fan shape.

Either of the two edges of the second light guide member 230 has a groove 232 extending therefrom. The groove 232 is shaped such that it extends from the edge into the inside portion of the second light guide member 230 in the plan view. The groove 232 extends continuously from the lower surface to the upper surface of the second light guide member 230, such that the groove 232 is open at both the lower and upper surfaces.

Among inner side walls of the groove 232, two inner side walls facing each other may form an angle of about 45 degrees with the edge of the second light guide member 230 in the plan view. The inner side wall closer to the arc edge of the second light guide member 230 among the two inner side walls of the groove 232 facing each other meets and is substantially coplanar with the incision surface 226 of the first light guide member 220 when the first light guide member 220 and the second light guide member 230 are coupled to each other.

As shown in FIG. 1 to FIG. 3 and FIG. 6, the light source unit 210 includes a first light source 214 and a second light source 216 that are separated from each other, and a printed circuit board (“PCB”) 212 on which the first light source 214 and the second light source 216 are mounted.

A circuit (not shown) which drives the first light source 214 and the second light source 216 is mounted in the PCB 212.

The first light source 214 and the second light source 216 may be disposed on a front surface of the PCB 212 of the light source unit 210. The first light source 214 is disposed at a lower end of the front surface of the PCB 212, and the second light source 216 is disposed at an opposing upper end of the front surface of the PCB 212.

The light source unit 210 is coupled to the groove 232 of the second light guide member 230, such as by being inserted into the groove 232. Also, the light source unit 210 is coupled to face and be substantially parallel to the incision surface 226 of the first light guide member 220.

In the state that the light source unit 210 is coupled to the first light guide member 220 and the second light guide member 230, the first light source 214 faces the incision surface 226 of the first light guide member 220. That is, the first light source 214 faces the inclined edge of the first light guide member 220 which is overlapped by the second light guide member 230. Accordingly, the first light source 214 supplies the light to the first light guide member 220. The first light source 214 may be disposed outside of the groove 232 defined in the second light guide member 230, such that the second light guide member 230 exposes the first light source 214 of the light source unit 210.

Also, in the state that the light source unit 210 is coupled to the first light guide member 220 and the second light guide member 230, the second light source 216 is positioned inside the groove 232 of the second light guide member 230. Accordingly, the second light source 216 supplies the light to the second light guide member 230.

The first light source 214 and the second light source 216 may respectively include a light emitting diode (“LED”) chip. In one exemplary embodiment, for example, the first light source 214 may include seventeen (17) LED chips, and the second light source 216 may include one LED chip. As a number of LED chips is increased, the light amount is increased.

The first light source 214 supplies the light to the first light guide member 220 and the second light source 216 supplies the light to the second light guide member 230 such that the amount of light of the first light source 214 and the second light source 216 may be controlled according to the area of the first light guide member 220 and the second light guide member 230. The planar area of the first light guide member 220 is larger than the planar area of the second light guide member 230. Accordingly, the light amount of the first light source 214 is higher than the light amount of the second light source 216.

A ratio of a number of LED chips of the second light source 216 to a number of LED chips of the first light source 214 may be determined by the ratio of the planar area of the second light guide member 230 to the planar area of the first light guide member 220. In one exemplary embodiment, for example, the ratio of the number of LED chips of the second light source 216 to the number of LED chips of the first light source 214 may be determined to be substantially equal to the ratio of the planar area of the second light guide member 230 to the planar area of the first light guide member 220.

In the illustrated exemplary embodiment of the backlight assembly according to the invention, by transmitting the light to a portion of a light guide member unit adjacent to the light source unit and a portion of the light guide member unit separated from the light source unit by using the different light guide members, a hot spot generated at the light incident portion may be reduced or effectively prevented and uniformity of the light supplied to the display panel may be improved. The first light guide member receives light from the first light source and uniformly transmits the light to the portion separated from the light source unit, and the second light guide member receives light from the second light source and uniformly transmits the light to the portion adjacent to the light source unit. Accordingly, the hot spot generated at the light incident portion may be reduced or effectively prevented.

Also, in the exemplary embodiment of the backlight assembly according to the invention, the light source unit is not positioned outside a planar boundary of the light guide member unit but is inserted inside a groove defined in one of the light guide members such that an increase in a bezel region of a display device due to a planar width of the light source unit and a planar distance between the light source unit and the light guide member unit is not generated.

Next, another exemplary embodiment of a backlight assembly according to the invention will be described with reference to FIG. 7.

The backlight assembly shown in FIG. 7 is substantially the same as the exemplary embodiment shown in FIG. 2 to FIG. 6 such that overlapping description thereof is omitted and differences will be described. As the largest difference from the previous exemplary embodiment, the backlight assembly further includes a reflection sheet.

FIG. 7 is a cross-sectional view of another exemplary embodiment of a backlight assembly according to the invention.

The backlight assembly includes the light source unit 210 supplying the light, and the first light guide member 220 and the second light guide member 230 receiving the light from the light source unit 210 and supplying the uniform light to the entire display panel (not shown). Although not shown, an optical sheet may be further disposed on the first light guide member 220 and the second light guide member 230, and a reflector may be disposed under the first light guide member 220 and the second light guide member 230.

The first light guide member 220 partially overlaps the second light guide member 230, and the second light guide member 230 is disposed on the first light guide member 220. The first light guide member 220 includes the first portion 222 overlapping the second light guide member 230, and the second portion 224. At the boundary of the first portion 222 and the second portion 224, the side surface of the first light guide member 220 faces and may contact a portion of the side surface of the second light guide member 230.

In the portion where the side surface of the first light guide member 220 and the side surface of the second light guide member 230 face and contact each other, a reflection sheet 240 is further disposed between the side surface of the first light guide member 220 and the side surface of the second light guide member 230. The reflection sheet 240 includes a material that reflects the light. The reflection sheet 240 may include a first surface facing the side surface of the first light guide member 220 and an opposing second surface facing the side surface of the second light guide member 230. In an exemplary embodiment, both the first and second surfaces of the reflection sheet 240 include the material reflecting the light.

When the light incident to the first light guide member 220 through the first light source 214 is directed toward the second light guide member 230, the light is reflected by the reflection sheet 240 such that the reflected light is not incident to the second light guide member 230. Also, when the light incident to the second light guide member 230 through the second light source 216 is directed toward the first light guide member 220, the light is reflected by the reflection sheet 240 such that the reflected light is not incident to the first light guide member 220. That is, the light incident to the first light guide member 220 and the light incident to the second light guide member 230 are independent, and the uniformity of the light supplied to the display panel may be improved.

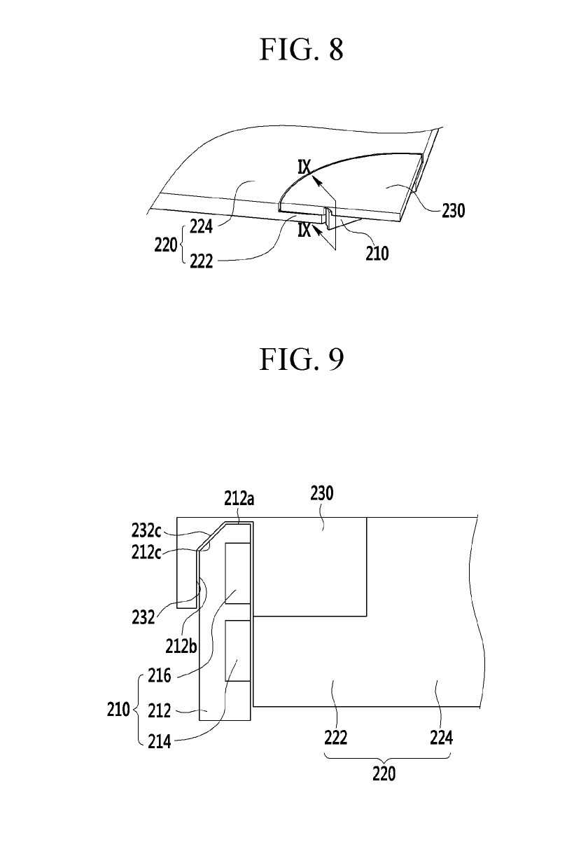

Next, still another exemplary embodiment of a backlight assembly according to the invention will be described with reference to FIG. 8 to FIG. 12.

The backlight assembly shown in FIG. 8 to FIG. 12 is substantially the same as the exemplary embodiment of the invention shown in FIG. 2 to FIG. 6, and therefore the duplicated description is omitted and only differences will be described hereinafter. The greatest differences from the previous exemplary embodiments are the groove of second light guide member and the shape of the light source unit, and these are described in detail.

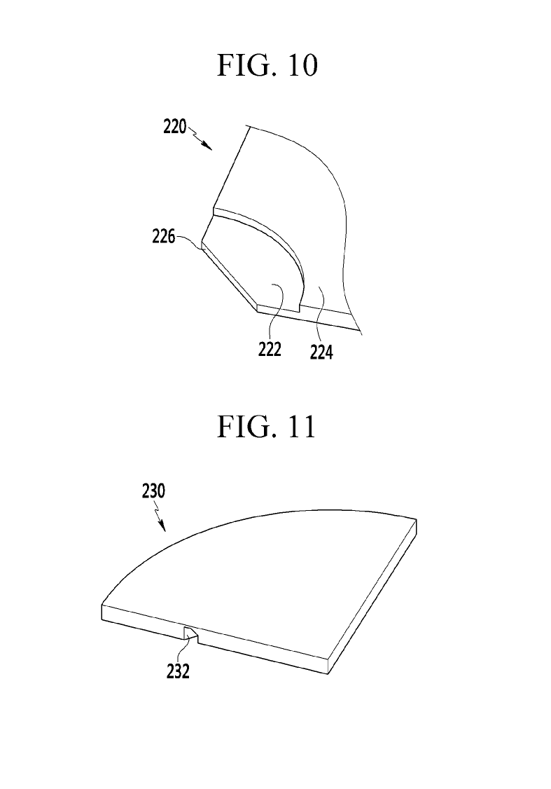

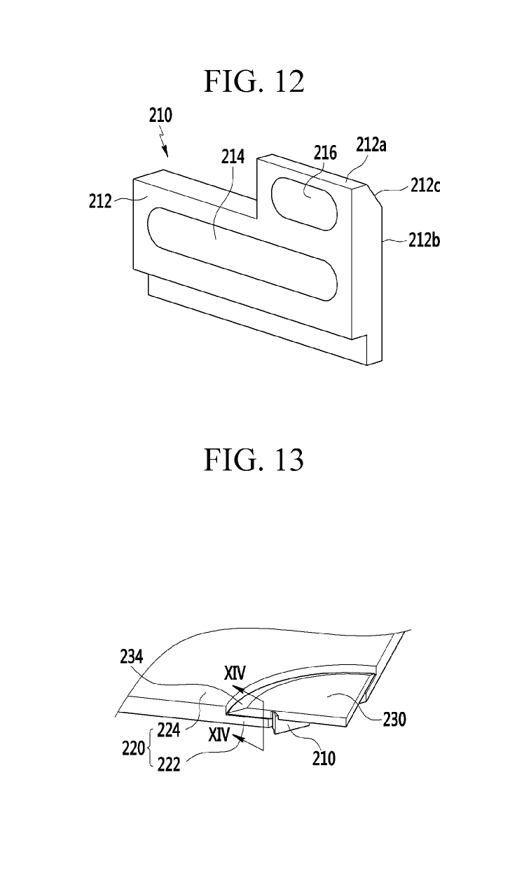

FIG. 8 is a perspective view of a portion of still another exemplary embodiment of a backlight assembly according to the invention, and FIG. 9 is a cross-sectional view of the backlight assembly in FIG. 8 taken along line IX-IX according to the invention. FIG. 10 is a perspective view of a portion of another exemplary embodiment of a first light guide member of a backlight assembly according to the invention, FIG. 11 is a perspective view of another exemplary embodiment of a second light guide member of a backlight assembly according to the invention, and FIG. 12 is a perspective view of another exemplary embodiment of a light source unit of a backlight assembly according to the invention.

The backlight assembly includes the light source unit 210 generating and supplying the light, and the first light guide member 220 and the second light guide member 230 receiving the light from the light source unit 210 and supplying the uniform light to the entire display panel (not shown). Although not shown, an optical sheet may be further disposed on the first light guide member 220 and the second light guide member 230, and/or a reflector 270 may be disposed under the first light guide member 220 and the second light guide member 230.

The upper surface of the second light guide member 230 may be defined with two edges and one arc edge. Either of the two edges of the second light guide member 230 has a groove 232 extending inwardly therefrom in the plan view. The groove 232 is shaped such that it extends from the edge into the inside portion of the second light guide member 230. The groove 232 extends through and is open at the bottom surface of the second light guide member 230. The groove 232 is spaced apart from the upper surface of the second light guide member 230. In contrast, the groove 232 in the previous exemplary embodiment extends continuously from the bottom surface to the upper surface of the second light guide member 230, such that the groove 232 is open at both the bottom and upper surfaces.

The light source unit 210 is coupled to the groove 232 of the second light guide member 230. In the state that the light source unit 210 is coupled to the second light guide member 230, a portion of the second light guide member 230 overlaps the light source unit 210 and is protruded from a main portion of the second light guide member 230. The protruded portion of the second light guide member 230 may form a groove with the main portion of the second light guide member 230, and the groove may be open in a direction opposite to the upper surface of the second light guide member 230. A horizontal first portion of the protruded portion of the second light guide member 230 at an inner wall of the groove 232 faces and covers (e.g., overlaps) an upper surface 212a of the PCB 212 of the light source unit 210.

The first light source 214 and the second light source 216 may be disposed on a front surface of the PCB 212. A rear surface 212b of the PCB 212 opposes the front surface. The virtual corner where the upper surface 212a and the rear surface 212b of the PCB 212 of the light source unit 210 meet each other is chamfered thereby forming a first inclination surface 212c.

The protruded portion of the second light guide member 230 which overlaps the light source unit 210 also faces the first inclination surfaces 212c and the rear surface 212b of the PCB 212. An inclined second portion of the protruded portion of the second light guide member 230 includes a second inclination surface 232c at the inner wall of the groove 232 and facing the first inclination surface 212c of the PCB 212. The first inclination surface 212c and the second inclination surface 232c have substantially the same inclination with respect a same reference line and may be parallel to each other. A vertical third portion of the protruded portion of the second light guide member 230 at an inner wall of the groove 232 faces the rear surface 212b of the PCB 212 of the light source unit 210. The rear surface 212b and the vertical third surface have substantially the same inclination with respect a same reference line and may be parallel to each other. A lower portion of the rear surface 212b of the PCB 212 of the light source unit 210 is exposed by the protruding portion of the second light guide member 230.

In the illustrated exemplary embodiment, the second light guide member 230 covers the upper surface 212a of the light source unit 210, and an inclination member of the light source unit 210 and an inclination member at the groove 232 of the second light guide member 230 are disposed such that the light amount from the second light guide member 230 is increased, and the light uniformity may be further improved.

Next, yet another exemplary embodiment of a backlight assembly according to the invention will be described with reference to FIG. 13 to FIG. 15.

The backlight assembly shown in FIG. 13 to FIG. 15 is substantially the same as the exemplary embodiment shown in FIG. 8 to FIG. 12, and therefore the duplicated description is omitted and only differences will be described hereinafter. The greatest difference from the previous exemplary embodiments is the shape of the light source unit, and this is described in detail.

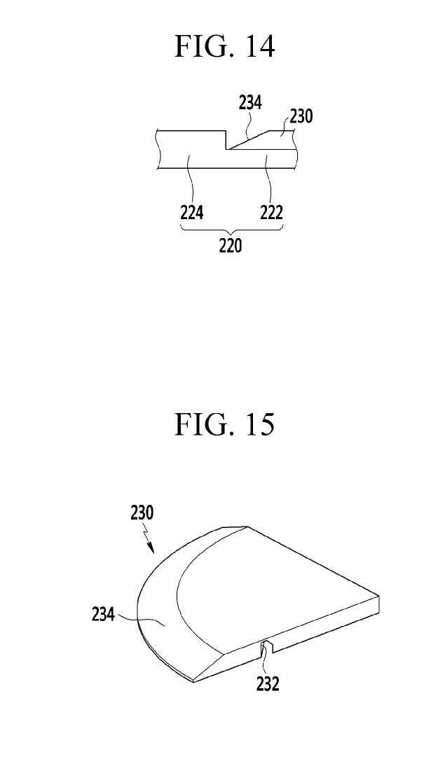

FIG. 13 is a perspective view of a portion of yet another exemplary embodiment of a backlight assembly according to the invention, FIG. 14 is a cross-sectional view of the backlight assembly in FIG. 13 taken along line XIV-XIV according to the invention, and FIG. 15 is a perspective view of still another exemplary embodiment of a second light guide member of a backlight assembly according to the invention.

The backlight assembly includes the light source unit 210 generating and supplying the light, and the first light guide member 220 and the second light guide member 230 receiving the light from the light source unit 210 and supplying the uniform light to the entire display panel (not shown). Although not shown, an optical sheet may be further disposed on the first light guide member 220 and the second light guide member 230, and a reflector 270 may be disposed under the first light guide member 220 and the second light guide member 230.

The upper surface of the second light guide member 230 may be approximately fan-shaped. That is, the upper surface of the second light guide member 230 may be defined with two edges and one arc. The two edges of the second light guide member 230 may overlap two edges of the first light guide member 220 contacting the incision surface 226 of the first light guide member 220. Also, the arc edge of the second light guide member 230 may overlap the boundary of the first portion 222 and the second portion 224 of the first light guide member 220. Accordingly, the boundary of the first portion 222 and the second portion 224 of the first light guide member 220 may be arc-shaped.

At the boundary of the first portion 222 and the second portion 224 of the first light guide member 220, the side surface of the first light guide member 220 and the side surface of the second light guide member 230 face each other. The side surface of the second light guide member 230 facing the side surface of the first light guide member 220 includes an inclination surface 234. The inclination surface 234 may extend from an upper surface to a rear surface of the second light guide member 230, or may be connected to the rear surface by a non-inclination surface.

By forming the inclination surface 234 at the side surface of the second light guide member 230, recognition by a user of the boundary where the first light guide member 220 and the second light guide member 230 face and/or contact may be reduced or effectively prevented.

In the illustrated exemplary embodiment, the inclination surface 212c of the light source unit 210 is disposed at the groove 232 of the second light guide member 230 including the protruding portion like the exemplary embodiment shown in FIG. 8 to FIG. 12, however, the invention is not limited thereto. In an alternative exemplary embodiment including the second light guide member 230 with the inclination surface 234, the inclination surface 212c of the light source unit 212 may not be disposed at the groove 232 of the second light guide member 230 and the second light guide member 230 may not include the protruding portion overlapping the light source unit 210 like the exemplary embodiment shown in FIG. 2 to FIG. 6.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A backlight assembly comprising:
a first light guide member;
a second light guide member overlapping the first light guide member;
a groove defined in the second light guide member; and
a light source unit in the groove, wherein the light source unit generates and supplies light to the first light guide member and the second light guide member.

2. The backlight assembly of claim 1, wherein
the second light guide member overlaps an inclined edge at a corner of the first light guide member in a plan view, and
the first light guide member comprises:
a first portion having a first thickness and overlapping the second light guide member, and
a remaining second portion having a second thickness larger than the first thickness.

3. The backlight assembly of claim 2, wherein
an upper surface of the second portion of the first light guide member and an upper surface of the second light guide member are coplanar.

4. The backlight assembly of claim 2, wherein
the light source unit comprises:
a first light source which generates and supplies the light to the first light guide member;
a second light source which generates and supplies the light to the second light guide member; and
a printed circuit board upon which the first and second light sources are disposed.

5. The backlight assembly of claim 4, wherein
the first light source faces the inclined edge of the first light guide member overlapped by the second light guide member, and
the second light source is inside the groove defined in the second light guide member.

6. The backlight assembly of claim 5, wherein
the first light source and the second light source respectively comprises a number of light emitting diode chips, and
a ratio of the number of light emitting diode chips of the second light source to the number of light emitting diode chips of the first light source is substantially equal to a ratio of a planar area of the second light guide member to a planar area of the first light guide member.

7. The backlight assembly of claim 1, wherein
the first light guide member comprises:
a first portion having a first thickness and overlapping the second light guide member, and
a remaining second portion having a second thickness larger than the first portion, and
at a boundary between the first and second portions of the first light guide member, a side surface of the first light guide member faces a side surface of the second light guide member,
further comprising a reflection sheet between the facing side surfaces.

8. The backlight assembly of claim 1, wherein
a protruded portion of the second light guide member overlaps an upper surface of the light source unit.

9. The backlight assembly of claim 8, wherein in a cross-sectional view,
the light source unit comprises a front surface facing a light incident side surface of the first light guide member, a rear surface opposing the front surface, and a first inclined surface connecting the upper and rear surfaces, and
the protruded portion of the second light guide member comprises a second inclined surface at the groove, wherein the second inclined surface the second light guide member faces the first inclined surface of the light source unit.

10. The backlight assembly of claim 1, wherein
the first light guide member comprises:
a first portion having a first thickness and overlapping the second light guide member, and
a remaining second portion having a second thickness larger than the first portion,
at a boundary between the first and second portions of the first light guide member, a side surface of the first light guide member faces a side surface of the second light guide member, and
in a cross-sectional view, the side surface of the second light guide member is inclined.

11. A display device comprising
a display panel which displays an image; and
a backlight assembly which generates and supplies a light to the display panel,
wherein the backlight assembly comprises:
a first light guide member which guides the light to the display panel;
a second light guide member which guides the light to the display panel and overlaps the first light guide member;
a groove defined in the second light guide member; and
a light source unit in the groove, wherein the light source unit generates and supplies the light to the first light guide member and the second light guide member.

12. The display device of claim 11, wherein
the second light guide member overlaps an inclined edge at a corner of the first light guide member in a plan view, and
the first light guide member comprises:
a first portion having a first thickness and overlapping the second light guide member, and
a remaining second portion having a second thickness larger than the first thickness.

13. The display device of claim 12, wherein
an upper surface of the second portion of the first light guide member and an upper surface of the second light guide member are coplanar.

14. The display device of claim 12, wherein
the light source unit comprises:
a first light source which generates and supplies the light to the first light guide member;
a second light source which generates and supplies the light to the second light guide member; and
a printed circuit board upon which the first and second light sources are disposed.

15. The display device of claim 14, wherein
the first light source faces the inclined edge of the first light guide member overlapped by the second light guide member, and
the second light source is inside the groove defined in the second light guide member.

16. The display device of claim 15, wherein
the first light source and the second light source respectively comprises a number of light emitting diode chips, and
a ratio of the number of light emitting diode chips of the second light source to the number of light emitting diode chips of the first light source is substantially equal to a ratio of a planar area of the second light guide member to a planar area of the first light guide member.

17. The display device of claim 11, wherein
the first light guide member comprises:
a first portion having a first thickness and overlapping the second light guide member, and
a remaining second portion having a second thickness larger than the first portion, and
at a boundary between the first and second portions of the first light guide member, a side surface of the first light guide member faces a side surface of the second light guide member,
further comprising a reflection sheet between the facing side surfaces.

18. The display device of claim 11, wherein
a protruded portion of the second light guide member overlaps an upper surface of the light source unit.

19. The display device of claim 18, wherein in a cross-sectional view,
the light source unit comprises a front surface facing a light incident side surface of the first light guide member, a rear surface opposing the front surface, and a first inclined surface connecting the upper and rear surfaces, and
the protruded portion of the second light guide member comprises a second inclined surface at the groove, the second inclined surface facing the first inclined surface.

20. The display device of claim 11, wherein
the first light guide member comprises:
a first portion having a first thickness and overlapping the second light guide member, and
a remaining second portion having a second thickness larger than the first portion,
at a boundary between the first and second portions of the first light guide member, a side surface of the first light guide member faces a side surface of the second light guide member, and
the side surface of the second light guide member is inclined.
